(19) United States
(12) Patent Application Publication
(10) Pub. No.: US 2005/0083273 A1
(43) Pub. Date: Apr. 21, 2005

(54) Circuit for driving light emitting device and matrix-type display panel employing the same

(76) Inventors: Jong Wook Seo, Seoul (KR); Young Kwan Kim, Kyungki-do (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/502,391

(22) PCT Filed: Jan. 29, 2003
(86) PCT No.: PCT/KR03/00208

(30) Foreign Application Priority Data
Jan. 29, 2002 (KR) 20025136

(51) Int. Cl. G09G 3/32

(52) U.S. Cl. 345/82

(57) ABSTRACT

A circuit for driving a light emitting device and a matrix-type display panel employing the same are provided. The circuit for driving a light emitting device having a first pole and a second pole opposite to the first pole includes a diode, which includes a first pole to which a predetermined data signal is applied and a second pole which is opposite to the first pole and is connected to the first pole of the light emitting device, and a capacitor, which includes a first terminal connected to a contact point between the first pole of the light emitting device and the second pole of the diode and a second terminal to which a predetermined control signal is applied. Accordingly, if the diode is turned on and the light emitting device is turned off, an electric charge which corresponds to a difference between a voltage level of the control signal and a voltage level of the data signal is charged, and if the diode is turned off and the light emitting device is turned on, the charged electric charge is discharged through the light emitting device.

### BACKGROUND OF THE INVENTION

This application claims the priority of Korean Patent Application No. 2002-5136, filed on Jan. 29, 2002, in the Korean Intellectual Property Office, the disclosure of which is incorporated herein in its entirety by reference.

1. Field of the Invention

The present invention relates to a circuit for driving a current control-type light emitting device and a matrix-type display panel employing the same, in which an electric power efficiency, quality, and reliability are improved.

2. Description of the Related Art

The demand for flat panel displays taking small spaces is increasing. A technique for an organic light emitting device, which is one of the flat panel displays, has been rapidly developed, and several new products using this type of display have been already announced.

The organic light emitting device can be driven at a voltage (5-10V) lower than a voltage in a plasma display panel (PDP) or an inorganic light emitting device. Thus, the organic light emitting device has been intensively studied. Also, since the organic light emitting device has excellent characteristics such as wide visual angle, high-speed response, and high contrast, it can constitute a pixel of a graphic display, a pixel of a television video display, or a surface light source. Also, unlike in a liquid crystal display (LCD), since the organic light emitting device does not require a back light, it has small power consumption and good color sensitivity and is suitable for an advanced flat panel display.

A thin film transistor (TFT) formed of low temperature poly silicon (LTPS) is used to drive the organic light emitting device. The TFT is widely used as a device for driving an organic light emitting device of an active matrix-type display that is integrated and formed on an insulating substrate.

A technique for forming a TFT on a substrate has been remarkably improved. Using the technique, an organic light emitting device constituting each pixel of an active matrix-type display panel and a TFT for driving the organic light emitting device can be formed on the same substrate. The TFT for driving the organic light emitting device is integrated and formed on the same substrate as a corresponding organic light emitting device such that costs can be reduced and a display can be small-sized.

However, a method for driving the organic light emitting device using the TFT is affected by a silicon crystal system forming the TFT, and in the method, current-voltage Id-Vg characteristics of each TFT show a quite large variation in a saturation region. Thus, in a display panel employing the TFT, even though a voltage level of a data signal input into each cell is uniform, the amount of light emitted from each organic light emitting device is nonuniform, and thus, it is difficult to obtain brightness of a corresponding cell accurately.

Also, since the organic light emitting device is driven by controlling current flowing through the organic light emitting device, several TFTs should be used. As such, due to usage of several TFTs, a complicated process for manufacturing a display panel should be performed.

In addition, if corresponding current is applied to a region through which a small amount of current is supposed to flow, the organic light emitting device emits light in proportion to an increase in the applied current. However, if over a predetermined amount of current is applied to the region, a loss rate caused by heat increases, and an efficiency of emitting light is relatively lowered. Thus, due to high brightness driving, reliability of a product is lowered.

### SUMMARY OF THE INVENTION

The present invention provides a circuit for driving a light emitting device in which electric devices for driving a light emitting device are simplified, such that a process for manufacturing a display panel is simplified, an electric power efficiency and reliability of a light emitting device are improved, and brightness of each pixel is accurately obtained.

The present invention also provides a matrix-type display panel employing the circuit for driving a light emitting device.

According to one aspect of the present invention, there is provided a circuit for driving a light emitting device having a first pole and a second pole opposite to the first pole, the circuit comprising: a diode which includes a first pole to which a predetermined data signal is applied and a second pole which is opposite to the first pole and is connected to the first pole of the light emitting device; and a capacitor which includes a first terminal connected to a contact point between the first pole of the light emitting device and the second pole of the diode and a second terminal to which a predetermined control signal is applied, in which, if the diode is turned on and the light emitting device is turned off, an electric charge which corresponds to a difference between a voltage level of the control signal and a voltage level of the data signal, is charged, and if the diode is turned off and the light emitting device is turned on, the charged electric charge is discharged through the light emitting device.

According to another aspect of the present invention, there is provided a matrix-type display panel in which scanning lines and signal lines are arranged in a matrix-shape on a substrate and which includes at least one cell in the vicinity of a cross point between the scanning line and the signal line, wherein each cell comprising: a light emitting device having a first pole and a second pole opposite to the first pole; a diode which includes a first pole to which a predetermined data signal is applied through the signal line and a second pole which is opposite to the first pole and is connected to the first pole of the light emitting device; and a capacitor which includes a first terminal connected to a contact point between the first pole of the light emitting device and the second pole of the diode and a second terminal to which a predetermined control signal is applied through the scanning line, in which, if the diode is turned on and the light emitting device is turned off, an electric charge which corresponds to a difference between a voltage level of the control signal and a voltage level of the data signal, is charged, and if the diode is turned off and the light emitting device is turned on, the charged electric charge is discharged through the light emitting device.

### BRIEF DESCRIPTION OF THE DRAWINGS

The above and other aspects and advantages of the present invention will become more apparent by describing in detail preferred embodiments thereof with reference to the attached drawings in which:

FIG. 1 illustrates a conventional matrix-type display panel;

FIG. 2 is a circuit diagram illustrating an embodiment of the structure of a circuit for driving a light emitting device according to the present invention;

FIG. 3 is a waveform diagram illustrating an embodiment of a control signal shown in FIG. 2;

FIG. 4 is a waveform diagram illustrating current flowing through a diode and a light emitting device shown in FIG. 2;

FIG. 5 is a circuit diagram illustrating another embodiment of the structure of a circuit for driving a light emitting device according to the present invention;

FIG. 6 is a waveform diagram illustrating an embodiment of a control signal shown in FIG. 5;

FIG. 7 illustrates an electric device for forming each cell of a matrix-type display panel to which the present invention is applied;

FIG. 8 illustrates a control signal applied to a row of each cell of the matrix-type display panel;

FIG. 9 is a circuit diagram illustrating an analog driving method by which the circuit for driving a light emitting device according to the present invention is implemented; and

FIG. 10 is a circuit diagram illustrating a digital driving method by which the circuit for driving a light emitting device according to the present invention is implemented.

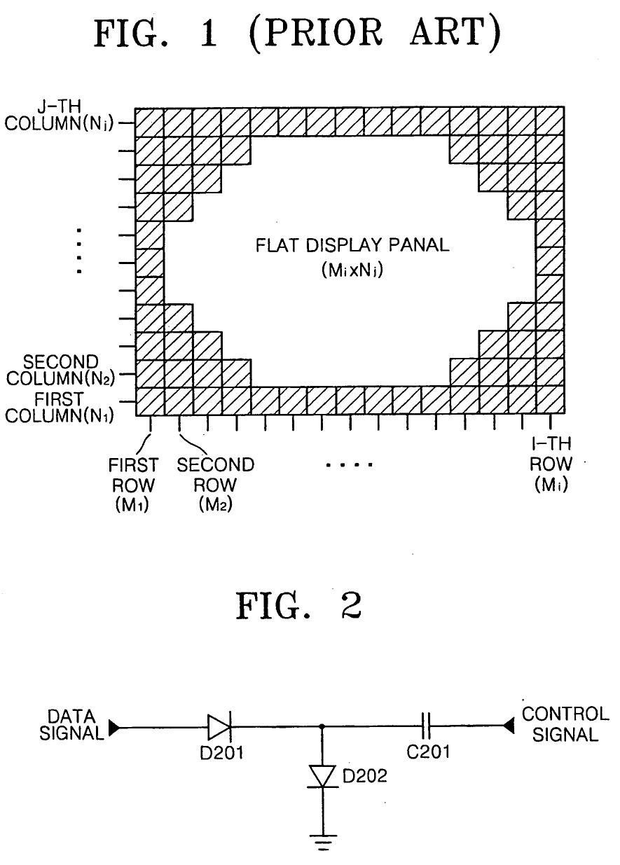

### DETAILED DESCRIPTION OF THE INVENTION

Hereinafter, the present invention will be described in detail by describing preferred embodiments of the invention with reference to the accompanying drawings.

FIG. 2 is a circuit diagram illustrating a first embodiment of the structure of a circuit for driving a light emitting device according to the present invention. Referring to FIG. 2, a diode D201 includes a first pole to which a predetermined data signal is applied, i.e., an anode terminal, and a second pole, i.e., a cathode terminal connected to a first pole of a light emitting device D202, i.e., an anode terminal. The light emitting device D202 includes a first pole, i.e., an anode terminal, and a second pole, i.e., a cathode terminal and emits light in proportion to the amount of current flowing therethrough. A capacitor C201 includes a first terminal connected to a contact point between the anode terminal of the light emitting device D202 and the cathode terminal of the diode D201, and a second terminal to which a predetermined control signal is applied. If the diode D201 is turned on and the light emitting device D202 is turned off, an electric charge which corresponds to a difference between a voltage level of the control signal and a voltage level of the data signal, is charged in the capacitor C201. If the diode D201 is turned off and the light emitting device D202 is turned on, the charged electric charge is discharged through the light emitting device D202. Here, the diode D201 is used as a switching device using a voltage difference between two terminals, and the light emitting device D202 may be implemented by one selected from an organic or inorganic electroluminescent light emitting device, a laser diode, or a light emitting diode. Preferably, an organic electroluminescent light emitting device is used as the light emitting device D202.

The operation of the circuit for driving a light emitting device having the above structure will be described below.

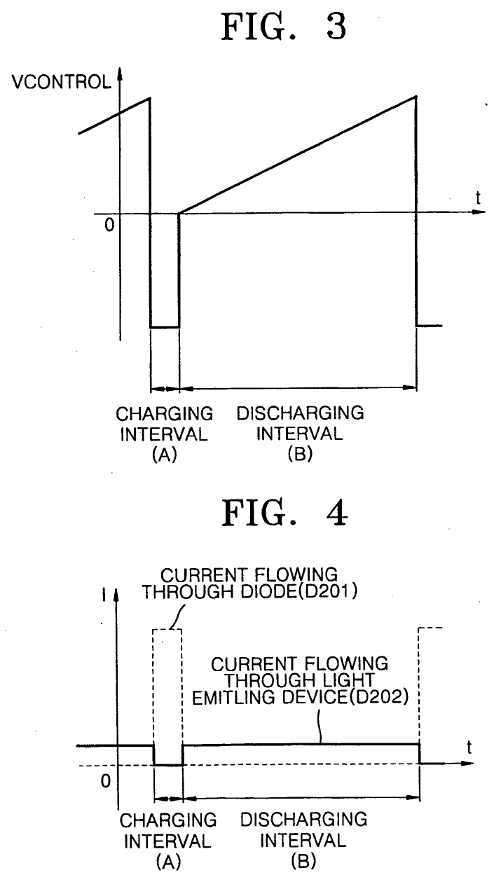

First, a control signal as shown in FIG. 3 is applied to the second terminal of the capacitor C201. A control signal of one cycle is composed of an interval A in which a voltage having a predetermined low level is maintained, and an interval B in which, after the voltage at the interval A jumps to a predetermined voltage, a voltage is increased by a predetermined rate from the jumped voltage to a predetermined positive of voltage. Here, the intervals A and B are referred to as a charging interval and a discharging interval, respectively, based on charging and discharging operations of the capacitor C201. As shown in FIG. 3, the control signal requires a predetermined size of voltage jump when the charging interval A is changed into the discharging interval B. Due to this voltage jump, the diode D201 is turned off such that cross talk between cells is prevented. Meanwhile, the control signal may be in a more simplified shape such as a square wave, unlike in a shape shown in FIG. 3.

The operation of the circuit for driving a light emitting device will be described in association with the charging and discharging intervals A and B of the control signal in response to a voltage level of the data signal applied to the anode terminal of the diode D201.

First, in the charging interval A to which a data signal having a high level is applied, a data signal having a high level is applied to the anode terminal of the diode D201, and a control signal having a low level is applied to the cathode terminal of the diode D201 and the anode terminal of the light emitting device D202 through the capacitor C201. As such, the diode D201 is turned on, whereas the light emitting device D202 is turned off.

Meanwhile, in the charging interval A, an electric charge which corresponds to a potential difference between a voltage level of the input control signal and a voltage level of the data signal input through the diode D201, is charged in the capacitor C201. That is, as shown in FIG. 4, current which corresponds to a potential difference between voltage levels of the control signal and the data signal, flows through the diode D201, and an electric charge is charged in the capacitor C201 by the flow of the current. The amount Q of an electric charge charged in the capacitor C201 may be obtained by multiplying a potential difference V between the voltage level of the input control signal and the voltage level of the data signal input through the diode D201 in the charging interval A by capacitance C of the capacitor C201, as defined in Equation 1.
Q=C×V (1)

Next, in the discharging interval B to which the data signal having a high level is applied, a control signal having a high level gradually increasing from a predetermined voltage, for example, 0V, is applied to the cathode terminal of the diode D201 and the anode terminal of the light emitting device D202 through the capacitor C201. The predetermined voltage jumps when the charging interval A of the control signal is changed into the discharging interval B, and thus, the diode D201 is turned off regardless of a voltage applied to its anode terminal, whereas the light emitting device D202 is turned on. Consequently, the electric charge charged in the capacitor C202 in the charging interval A is discharged through the light emitting device D202 according to a voltage of the control signal which increases at a predetermined rate as time passes. In this case, the diode D201 is turned off. Thus, as shown in FIG. 4, current does not flow through the diode D201, and the light emitting device D202 is turned on such that a current path is formed between the capacitor C201 and the light emitting device D202 and current flows through the light emitting device D202. The amount I of current discharged through the light emitting device D202 in the discharging interval B may be obtained by Equation 2.

$$I = \frac{Q}{t} \qquad ( 2 )$$

Here, t is a time in which the discharging interval B of the control signal continues, and Q is the amount of an electric charge charged in the capacitor C201 in the charging interval A.

When the data signal having a high level is applied, the amount I of current discharged in the light emitting device D202 may be obtained by Equation 3 from Equations 1 and 2.

$$I = \frac{C \times V}{t} \qquad ( 3 )$$

That is, the amount I of current discharged through the light emitting device D202 is determined by capacitance C of the capacitor C201, a potential difference V between a voltage level of a control signal applied to a row of a corresponding cell and a voltage level of a data signal applied to a column of the cell in the charging interval A, and a time t at which the control signal applied in the discharging interval B continues.

In conclusion, when the data signal having a high level is applied, the light emitting device D202 emits light in proportion to the amount I of current as defined in Equation 3 in the discharging interval B of the control signal. Meanwhile, in the charging interval A to which a data signal having a low level is applied, a data signal having a low level is applied to the anode terminal of the diode D201, and a control signal having a low level is applied to the cathode terminal of the diode D201 and the anode terminal of the light emitting device D202 through the capacitor C201. As such, the diode D201 and the light emitting device D202 are turned off, and thus, an electrical charge is not charged in the capacitor C201. In order to turn off the diode D201 in the charging interval A, the low level of the data signal applied to the anode terminal of the diode D201 is set to be not greater than the voltage level of the control signal applied to the cathode terminal of the diode D201 in the charging interval A.

Next, in the discharging interval B to which the data signal having a low level is applied, the data signal having a low level is applied to the anode terminal of the diode D201, and a control signal having a high level is applied to the cathode terminal of the diode D201 and the anode terminal of the light emitting device D202 through the capacitor C201. As such, the diode D201 is turned off, and the light emitting device D202 is turned on. However, in this case, there is no electric charge charged in the capacitor C201. That is, even though the control signal increases to a high level, a voltage at both terminals of the capacitor C201 is maintained to be lower than a voltage needed to turn on the light emitting device D202. Thus, current does not flow through the light emitting device D202, and the light emitting device D202 does not emit light. In conclusion, when the data signal having a low level is applied, the light emitting device D202 does not emit light.

To sum up, the amount of current flowing through the light emitting device forming each cell is controlled in response to the data signal applied to a column of each cell of a display such that brightness of each cell can be accurately obtained. In the above embodiment, the diode D201, the light emitting device D202, and the capacitor C201 are implemented using a single structure, respectively. However, according to brightness or graduation required in a video display employing the circuit for driving a light emitting device, at least one or more diodes may be connected in series, or at least one or more capacitors may be connected in parallel, or at least one or more light emitting devices may be connected in parallel.

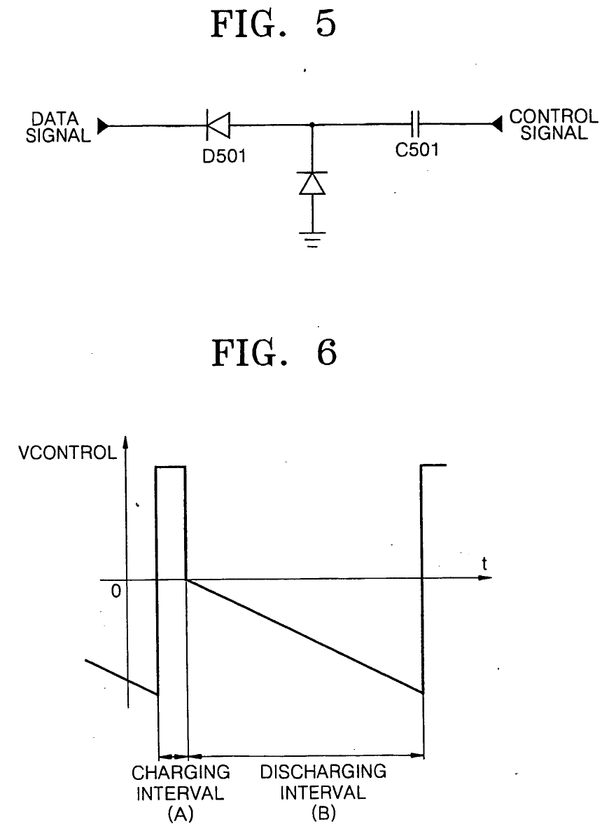

FIG. 5 is a circuit diagram illustrating a second embodiment of the structure of a circuit for driving a light emitting device according to the present invention. A case where polarities of the diode D201 and the light emitting device D202 shown in FIG. 2 are reversely connected, is shown in FIG. 5.

Referring to FIG. 5, a predetermined data signal is applied to a cathode terminal of a diode D501, and an anode terminal of the diode D501 is connected to a cathode terminal of a light emitting device D502. Meanwhile, a first terminal of the capacitor C501 is connected to a contact point between the cathode terminal of the light emitting device D502 and the anode terminal of the diode D501, and a predetermined control signal is applied to the second terminal of the capacitor C501. As shown in FIG. 6, the control signal applied to the second terminal of the capacitor C501 has a polarity opposite to a polarity of the control signal shown in FIG. 3, and polarity of the data signal is also opposite to a polarity of the data signal in FIG. 3. In this case, the circuit for driving a light emitting device according to the second embodiment in a charging interval A and a discharging interval B operates in the same manner as in the first embodiment shown in FIG. 2.

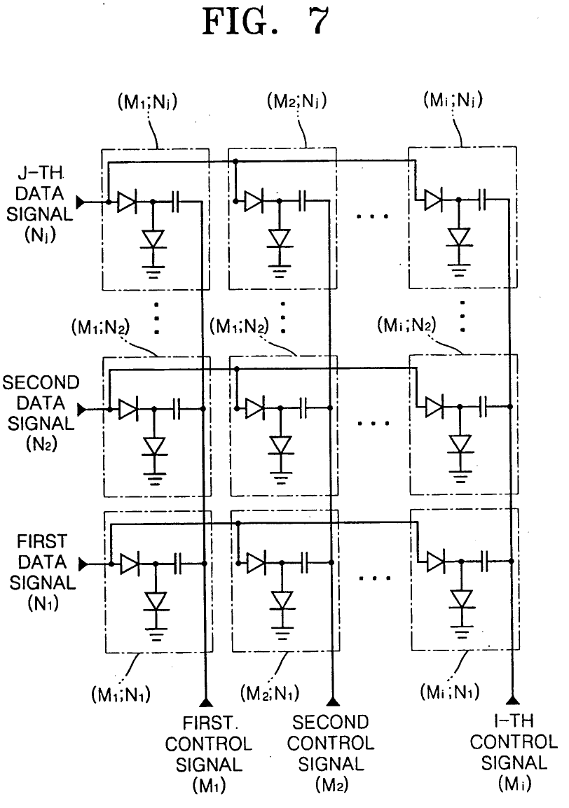

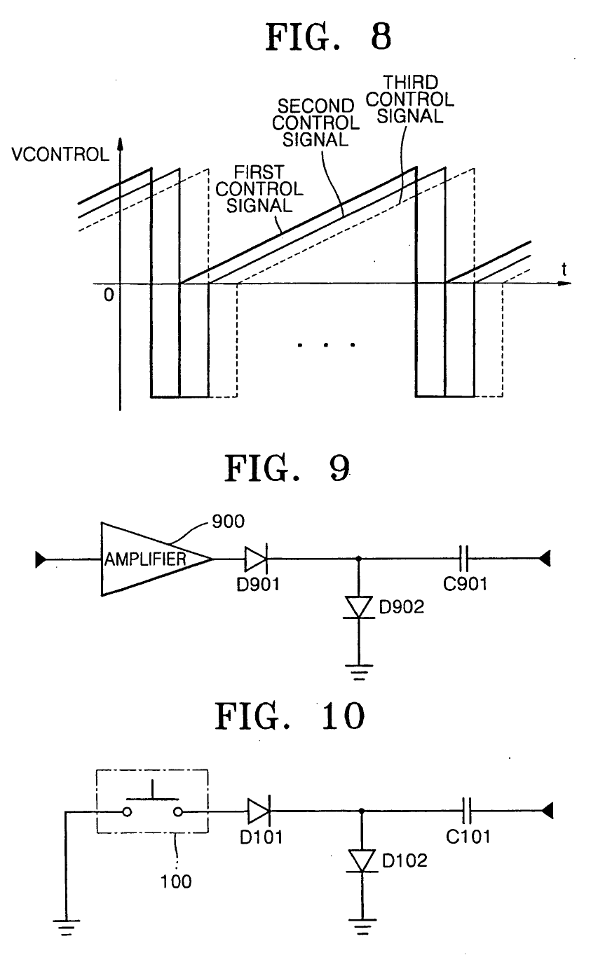

FIG. 7 illustrates a matrix-type display panel to which a circuit for driving a light emitting device according to the present invention is applied. Referring to FIG. 7, scanning lines and signal lines are formed in a matrix shape on a substrate, and at least one cell placed in the vicinity of a cross point between the scanning line and the signal line is arranged in a two-dimensional array shape Mᵢ×Nⱼ. A control signal used to scan each row progressively is applied to a horizontal scanning line, and a data signal (or image signal) in synchronization with the control signal is applied to a vertical signal line, i.e., a column of each cell. Each cell is composed of a diode, a capacitor, and a light emitting device having a connection structure shown in FIG. 2. Thus, the data signal in the signal line is applied to the anode terminal of the diode, and the control signal in the scanning line is applied to the capacitor. A control signal having a predetermined phase delay as shown in FIG. 8 is applied to a row of each cell, and a data signal having a predetermined voltage level, in synchronization with the charging interval A of the control signal applied to each row so as to obtain brightness of a corresponding cell, is applied to a column of each cell.

Subsequently, in the circuit for driving a light emitting device shown in FIG. 2, according to the present invention, a method for driving a light emitting device by which a data signal is applied to a column of a predetermined cell using an analog method, will be described below with reference to FIG. 9.

Referring to FIG. 9, a circuit for driving a light emitting device using the analog method is different from the circuit for driving a light emitting device shown in FIG. 2 in that an amplifier 900 is added between an anode terminal of a diode D901 and a signal line.

The amplifier 900 amplifies a predetermined data signal with a predetermined gain and outputs an analog data signal having a predetermined voltage level so that an electric charge which corresponds to the amount of current needed in optimum cell brightness is charged in the capacitor C901 in a charging interval A of a control signal. The analog data signal amplified by the amplifier 900 is applied to the anode terminal of the diode D901, and the control signal in the charging interval A is applied to a cathode terminal of the diode D901.

As in the charging interval A, the diode D901 is turned on and the light emitting device D902 is turned off, an electric charge which corresponds to a potential difference between a voltage level of the control signal in the charging interval A and a voltage level of the analog data signal amplified by the amplifier 900, is charged in the capacitor C901.

As after the charging interval A is terminated, in a discharging interval B, the diode D901 is turned off and the light emitting device D902 is turned on, current determined by the amount of an electric charge charged in the capacitor C901 and an increase rate of the voltage of the control signal, is discharged through the light emitting device D902. In this case, the light emitting device D902 emits light which corresponds to the amount of current.

Thus, the amount of current flowing through the light emitting device D902 is controlled in response to the analog data signal amplified by the amplifier 900 such that brightness of a corresponding cell can be accurately obtained.

Here, preferably, a cycle of the control signal applied to a row of a predetermined cell has a value at maximum which corresponds to a frame cycle of a display panel, and the width of the charging interval A of the control signal is set to be a value obtained by dividing the cycle of the control signal by the number of rows of the display. Thus, in order to increase brightness of the cell, capacitance of the capacitor C901 is increased, or the cycle of the control signal is set to be shorter than the frame cycle to a predetermined multiple such that a method for driving a light emitting device repeatedly according to the predetermined multiple can be used.

Also, in the circuit for driving a light emitting device using the analog method shown in FIG. 9, a clipping unit (not shown) which clips the voltage level of the input data signal to a predetermined value, may be added to a front end of the amplifier 900.

Subsequently, in the circuit for driving a light emitting device shown in FIG. 2, according to the present invention, a method for driving a light emitting device by which a data signal is applied to a column of a predetermined cell using a digital method, will be described below with reference to FIG. 10.

Referring to FIG. 10, a circuit for driving a light emitting device D102 using the digital method includes a switching device 100 connected between a ground and an anode terminal of a diode D101, a the diode D101, the light emitting device D102, and a capacitor C101. Here, the anode terminal of the diode D201 needs not to be connected to the ground and may be connected to a voltage source having a turn-on voltage sufficient to turn on the diode D201 in the charging interval A of FIG. 3.

The switching device 100 is switched in response to a predetermined switching signal and allows the anode terminal of the diode D101 to be in one state selected from a ground state, or a state where a turn-on voltage is applied, and a floating state. That is, only when the switching device 100 is turned on in response to the switching signal, 0V or a turn-on voltage is applied to the anode terminal of the diode D101.

The operation of the circuit for driving a light emitting device will be described in association with each interval of a control signal when the switching device 100 is turned on and/off.

If the switching device 100 is turned on and 0V of a digital data signal is applied to the anode terminal of the diode D101, in the charging interval A, a control signal having a low level is applied to a cathode terminal of the diode D101. Then, the diode D101 is turned on, and the light emitting device D102 is turned off. In this case, an electric charge which corresponds to a potential difference between a voltage level of the control signal in the charging interval A and the voltage level 0V of the digital data signal, is charged in the capacitor C101. Subsequently, if the control signal in the discharging interval B is applied to the capacitor C101, the diode D101 is turned off and the light emitting device D102 is turned on, the capacitor C101 discharges, and current determined by the amount of electric charge charged in the capacitor. C101 and an increase rate of the voltage of the control signal flows through the light emitting device D102. Then, the light emitting device D102 emits light which corresponds to the amount of current.

Meanwhile, if the switching device 100 is turned off and the anode terminal of the diode D101 is in a floating state, a potential difference between the voltage level of the digital data signal input into the anode terminal of the diode D101 and the voltage level of the control signal does not occur in the charging interval A. Consequently, flow of current does not occur, and thus, an electric charge is not charged in the capacitor C101. Also, even though the control signal in the discharging interval B is applied to the capacitor C101, there is no electric charge charged in the capacitor C101. Thus, current is not discharged through the light emitting device D102, and the light emitting device D102 does not emit light.

Thus, the amount of current flowing through the light emitting device D102 is controlled in response to the digital data signal generated when the switching device 100 is turned on and/off such that brightness of a corresponding cell can be accurately obtained. Brightness of each cell is determined depending on how often current flows through the light emitting device D102 during one frame cycle, that is, how often the light emitting device D102 is turned on. For example, in the case of 8-bit gray scale, brightness of a corresponding cell is determined depending on the number of times when the light emitting device D102 emits light when a control signal is applied to each cell 255 times during one frame cycle.

For example, when a predetermined cell is set to be the darkest, the switching device 100 is continuously maintained in an off state while scanning is performed 255 times. On the other hand, when the cell is set to be the brightest, the switching device 100 is continuously maintained in an on state while scanning is performed 255 times.

Thus, the circuit for driving a light emitting device according to the present invention, while a control signal in a charging interval A is applied to a row of each cell, controls the amount of current flowing through the light emitting device in response to a data signal applied to a column of each cell such that brightness of each cell can be accurately obtained.

As described above, the circuit for driving a light emitting device according to the present invention has the following advantages.

First, by applying the amount of current maintained uniformly during an array scanning cycle to a light emitting device forming each cell of a display panel, for example, to an organic electroluminescent light emitting device, each cell is driven such that an electric power efficiency of a display can be increased and reliability of a product can be improved. Second, by driving the light emitting device at an optimum current value, brightness of each cell of a display panel is accurately obtained, such that quality of a product can be improved. In addition, by using a diode and a capacitor the light emitting device is driven such that a manufacturing process for a circuit related to driving of each cell can be simplified. Third, high-speed switching according to the turn-on characteristics of a diode can be performed, such that a digital driving method can be easily applied, and further, accurate gray scale can be achieved. Fourth, as the diode is turned off using a control signal in which a voltage jumps to a predetermined value, a discharging operation of a capacitor is performed. As a result, cross talk between cells can be prevented, the light emitting device can emit a predetermined amount of light according to a specified frame rate, and the same effect as in an active matrix-type display panel can be obtained.

The circuit for driving a light emitting device according to the present invention is applied to a video display having a matrix-type display panel employing a current control-type light emitting device such that an electric power efficiency, quality, and reliability of the display panel can be improved, a process for manufacturing the display can be simplified and costs can be reduced.

While this invention has been particularly shown and described with reference to preferred embodiments thereof, it will be understood by those skilled in the art that various changes in form and details may be made therein without departing from the spirit and scope of the invention as defined by the appended claims.

1. A circuit for driving a light emitting device having a first pole and a second pole opposite to the first pole, the circuit comprising:
a diode which includes a first pole to which a predetermined data signal is applied and a second pole which is opposite to the first pole and is connected to the first pole of the light emitting device; and
a capacitor which includes a first terminal connected to a contact point between the first pole of the light emitting device and the second pole of the diode and a second terminal to which a predetermined control signal is applied, in which, if the diode is turned on and the light emitting device is turned off, an electric charge which corresponds to a difference between a voltage level of the control signal and a voltage level of the data signal, is charged, and if the diode is turned off and the light emitting device is turned on, the charged electric charge is discharged through the light emitting device.

2. The circuit of claim 1, wherein the first pole of the diode and the first pole of the light emitting device are anodes, and the second pole of the diode and the second pole of the light emitting device are cathodes.

3. The circuit of claim 2, wherein one cycle of the control signal is composed of a first interval and a second interval, and the first interval has a predetermined low-level voltage, and the second interval has a high-level voltage in which, after the voltage in the first interval jumps to a predetermined voltage, the voltage is increased by a predetermined rate.

4. The circuit of claim 3, wherein the light emitting device emits light in the second interval, and the amount of current flowing through the light emitting device is determined by a potential difference between the high-level voltage of the data signal applied to the first pole of the diode in the first interval and the low-level voltage of the control signal, capacitance of the capacitor, and the length of the second interval.

5. The circuit of claim 1, wherein the first pole of the diode and the first pole of the light emitting device are cathodes, and the second pole of the diode and the second pole of the light emitting device are anodes.

6. The circuit of claim 5, wherein one cycle of the control signal is composed of a first interval and a second interval, and the first interval has a predetermined high-level voltage, and the second interval has a low-level voltage in which, after the voltage in the first interval jumps to a predetermined voltage, the voltage is decreased by a predetermined rate.

7. The circuit of claim 6, wherein the light emitting device emits light in the second interval, and the amount of current flowing through the light emitting device is determined by a potential difference between the low-level voltage of the data signal applied to the first pole of the diode in the first interval and the high-level voltage of the control signal, capacitance of the capacitor, and the length of the second interval.

8. The circuit of claim 6, further comprising a switching device connected between a voltage source having a turn-on voltage required to turn on the diode in the first interval of the control signal and the first pole of the diode, which is switched in response to a predetermined switching signal such that the first pole of the diode is in one state selected from a state where the turn-on voltage is applied and a floating state.

9. The circuit of claim 8, wherein brightness of the light emitting device is controlled by the number of times when the light emitting device is turned on during one frame cycle, and the number of turns-on is set by the switching signal.

10. The circuit of claim 1, further comprising an amplifier which is connected to the first pole of the diode and amplifies a voltage level of the data signal to correspond to desired brightness of the light emitting device.

11. A matrix-type display panel in which scanning lines and signal lines are arranged in a matrix-shape on a substrate and which includes at least one cell in the vicinity of a cross point between the scanning line and the signal line, wherein each cell comprising:
a light emitting device having a first pole and a second pole opposite to the first pole;
a diode which includes a first pole to which a predetermined data signal is applied through the signal line and a second pole which is opposite to the first pole and is connected to the first pole of the light emitting device; and
a capacitor which includes a first terminal connected to a contact point between the first pole of the light emitting device and the second pole of the diode and a second terminal to which a predetermined control signal is applied through the scanning line, in which, if the diode is turned on and the light emitting device is turned off, an electric charge which corresponds to a difference between a voltage level of the control signal and a voltage level of the data signal, is charged, and if the diode is turned off and the light emitting device is turned on, the charged electric charge is discharged through the light emitting device.

12. The panel of claim 11, wherein the first pole of the diode and the first pole of the light emitting device are anodes, and the second pole of the diode and the second pole of the light emitting device are cathodes.

13. The panel of claim 12, wherein a control signal having predetermined phase delay is applied to a row of each cell, and one cycle of the control signal is composed of a first interval and a second interval, and the first interval has a predetermined low-level voltage, and the second interval has a high-level voltage in which, after the voltage in the first interval jumps to a predetermined voltage, a voltage is increased by a predetermined rate.

14. The panel of claim 13, wherein the light emitting device emits light in the second interval, and the amount of current flowing through the light emitting device is determined by a potential difference between the high-level voltage of the data signal applied to the first pole of the diode in the first interval and the low-level voltage of the control signal, capacitance of the capacitor, and the length of the second interval.

15. The panel of claim 11, wherein the first pole of the diode and the first pole of the light emitting device are cathodes, and the second pole of the diode and the second pole of the light emitting device are anodes.

16. The panel of claim 15, wherein a control signal having predetermined phase delay is applied to a row of each cell, and one cycle of the control signal is composed of a first interval and a second interval, and the first interval has a predetermined high-level voltage, and the second interval has a low-level voltage in which, after the voltage in the first interval jumps to a predetermined voltage, a voltage is decreased by a predetermined rate.

17. The panel of claim 16, wherein the light emitting device emits light at the second interval, and the amount of current flowing through the light emitting device is determined by a potential difference between the high-level voltage of the data signal applied to the first pole of the diode in the first interval and the low-level voltage of the control signal, capacitance of the capacitor, and the length of the second interval.

18. The panel of claim 13, wherein the cycle of the control signal applied to a row of each cell has a value at maximum which corresponds to a frame cycle of the display panel.

19. The panel of claim 18, wherein the width of the first interval of the control signal is set to be a value obtained by dividing the cycle of the control signal by the number of rows of the display panel.
